(19) United States
(12) Patent Application Publication
(10) Pub. No.: US 2007/0153402 A1
(43) Pub. Date: Jul. 5, 2007

(54) Fresnel lens combination

(76) Inventor: Patrick R. Destain, Loveland, OH (US)

Correspondence Address: 3M INNOVATIVE PROPERTIES COMPANY, PO BOX 33427, ST. PAUL, MN, 55133-3427, US

(21) Appl. No.: 11/322,981

(22) Filed: Dec. 30, 2005

(51) Int. Cl. G02B 3/08

(52) U.S. Cl. 359/742

(57) ABSTRACT

A focusing unit includes a Fresnel lens combination, where the Fresnel lenses are oriented to reduce shadowing losses. Shadowing is a scattering of light from reflection at the facet walls that separate adjacent Fresnel zones on a given Fresnel lens. Two substantially adjacent Fresnel lenses make up the focusing unit, which can be used as a condenser that collects light from a source in a projection system. Both Fresnel lenses have non-faceted sides that face the light source. The first Fresnel lens collimates the light from the source. The second Fresnel lens receives the collimated beam, with a range of incident angles determined by the spatial extent of the source. Components such as reflective polarizers and anti-reflection coatings can be used between the Fresnel lenses and can be applied to the non-faceted side of the second Fresnel lens.

### FIELD OF THE INVENTION

The present invention is directed to a combination of Fresnel lenses for a condenser for a projection system.

### BACKGROUND

Fresnel lenses are becoming increasingly more common. They are generally more compact and less expensive than their bulk optic counterparts, and are well-suited for optical systems that do not require a high wavefront quality. One such system is the illumination-portion of a projection system, which gathers as much light as possible from an extended source and directs it onto a pixilated panel.

It is desirable to maximize the throughput or transmission through the lens, which involves reducing or eliminating the problem of shadowing. Shadowing is a scattering of light at the facets of the Fresnel lens, caused by total internal reflection from the facet walls that separate the Fresnel zones.

### BRIEF SUMMARY

The present application discloses, inter alia, a focusing unit, comprising a first Fresnel lens having a first non-faceted side for receiving a first non-collimated beam and a first faceted side for emitting a collimated beam; and a second Fresnel lens having a second non-faceted side for receiving the collimated beam and a second faceted side for emitting a second non-collimated beam. No pixilated panel is disposed between the first faceted side and the second faceted side.

Also disclosed is a focusing unit, comprising a first Fresnel lens having a first non-faceted side for receiving a first non-collimated beam and a first faceted side for emitting a collimated beam; and a second Fresnel lens having a second non-faceted side for receiving the collimated beam substantially directly from the first faceted side and a second faceted side for emitting a second non-collimated beam.

Also disclosed is a focusing unit, comprising a first Fresnel lens having a first non-faceted side for receiving a first non-collimated beam and a first faceted side for emitting a collimated beam; and a second Fresnel lens having a second non-faceted side for receiving the collimated beam and a second faceted side for emitting a second non-collimated beam. The collimated beam is not temporally modulated.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a plan drawing of one embodiment of an illumination system.

FIG. 2 is a plan drawing of one embodiment of a Fresnel lens combination, for an on-axis bundle of rays.

FIG. 3 is a plan drawing of one embodiment of a Fresnel lens combination, for an off-axis bundle of rays.

FIG. 4 is a plan drawing of a Fresnel lens facet suffering from shadowing.

FIG. 5 is a plan drawing of a Fresnel lens facet free from shadowing.

### DETAILED DESCRIPTION OF ILLUSTRATIVE EMBODIMENTS

Projection systems are becoming increasingly common for television systems, conference rooms, and theaters, with an ongoing effort to make them smaller and less expensive.

In one type of projection system, light from a source is collected by a condenser and directed onto a pixilated panel, such as a liquid crystal on silicon (LCOS) panel. The light reflected from the pixilated panel is then imaged onto a distant screen by a projection lens. In this type of projection system, the pixilated panel is generally tiny, compared to the viewable image on the screen, and it is generally considered desirable to situate the source, the condenser, the pixilated panel, and the intervening optics (excluding the projection lens) in the smallest possible volume with the fewest number of components.

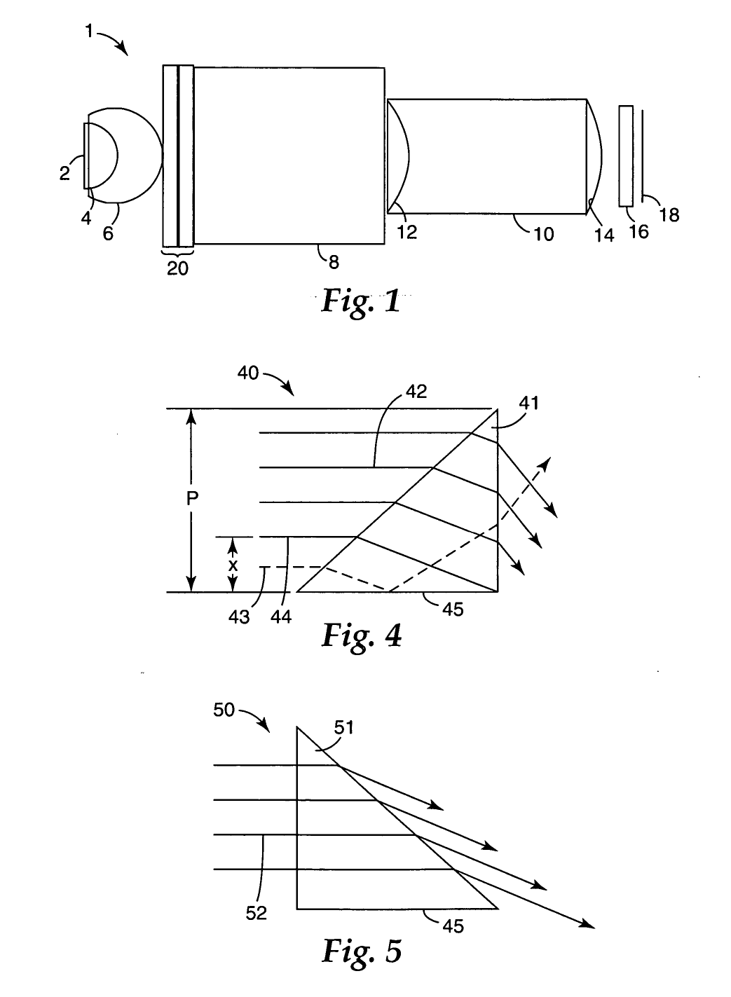

FIG. 1 shows one exemplary embodiment of an optical system 1 for a projection system. The source 2 is an LED array, which preferably has a generally rectangular outer shape with an aspect ratio that matches that of the pixilated panel 18, such as 4:3 or 16:9. Alternatively, the LED array can have a different aspect ratio than that of the pixilated panel, and anamorphic optics (discussed further below) can be used to shape the illumination beam to match the size of the pixilated panel. The LED array may have bright regions of emission, with dark regions that correspond to non-emitting structures, such as wires or electrical connections, or gaps between die or other support elements. A typical LED array may emit a luminous flux of about 20 lumens, although any suitable value may be used. Such an array may consume an electrical power of about one watt, which is much smaller than the required electrical power for a comparable arc lamp. Note that some LED arrays emit light in a fairly narrow range of wavelengths. For example, the LED array may emit in the blue region of the spectrum, so that when viewed by a human eye, its entire range of wavelengths appears to be essentially blue. Alternatively, the LED array may emit in the red, in the green, or in some other suitable portion of the spectrum. In some embodiments, white-light emitting LEDs (containing phosphors, or multiple dies emitting different colors) may be used.

Light from the source 2 is collected by a multi-element condenser, which in FIG. 1 is elements 4 through 16 and 20, collectively. Each of these is described below. This condenser is merely exemplary, and any suitable condenser may be used, having one or more refractive, reflective, and/or diffractive elements.

Light from the source enters a compound encapsulant lens. The lens can be a doublet as shown, having an inner lens 4 and an outer lens 6 in intimate contact with each other. Where the light source is an LED die array connected by wire bond(s), the inner lens 4 preferably encompasses the LED die array and wire bond(s) in a substantially plano-convex space, where the radius of curvature and axial position of the convex surface are selected to minimize the volume of the space, and therefore of the lens. Such lens 4 may be composed of a liquid or gel, or cured polymer material, and may have a refractive index of about 1.5. The outer lens 6 is preferably composed of a relatively high refractive index material, e.g., a glass whose refractive index is about 2 or more. Lens 6 also preferably has a meniscus shape, the outer surface of which can be designed to be substantially aplanatic, i.e., having little or no spherical aberration or coma, at least for a specified portion of the light source, such as an edge portion at the extreme lateral edge of the light source or an intermediate portion between the lateral edge and the optical axis. The inner surface of lens 6 mates with the outer surface of inner lens 4. The encapsulant lens is described more fully in commonly assigned U.S. Application entitled “LED With Compound Encapsulant Lens” (Attorney Docket No. 61677US002), filed on even date herewith and incorporated herein by reference.

Following the encapsulant lens is a pair of Fresnel lenses 20. The first Fresnel lens may be selected to substantially collimate the beam. The incident face of the second Fresnel lens may have a polarizing film or element on it, such as a reflective polarizer that transmits one polarization and reflects the other. Incorporating a polarizer on the second Fresnel lens, or otherwise mounting one between the Fresnel lenses or at another position close to the light source, provides a polarized light beam to optical elements downstream in the system, which may be useful as described further below. The second Fresnel lens converges the beam.

The beam then enters a beamsplitting color combiner 8, sometimes referred to as an X-cube color combiner, in which both hypotenuses in a particular dimension have color-sensitive coatings that can reflect one wavelength band and transmit another, the coatings usually being optimized for s-polarized light. (The color combiner is shown schematically in FIG. 1, and thus the hypotenuses are not shown.) The reader will understand that only one color channel is shown in FIG. 1 for simplicity, but for a full color projection system the optical system 1 will have two additional color channels, replicating elements 2, 4, 6, 20 for each color channel except that the source 2 emits red, green, or blue light respectively for a given channel. The resulting three color channels couple to different sides of the color combiner 8, forming a red arm, a green arm, and a blue arm, where each arm has its own source and lens components. The output from the color combiner has light from all three arms superimposed, and all three wavelength bands illuminate the pixilated panel along the same optical path (downstream of the color combiner). Preferably, the color combiner 8 transmits green wavelengths while reflecting blue and red, although other suitable configurations may be used.

Following the color combiner is a polarizing beam splitter 10, which has a broadband polarization-sensitive coating or element along its hypotenuse (not shown). The hypotenuse transmits one polarization state while reflecting the orthogonal polarization state. The polarizing beam splitter 10 can have flat outer faces or, as shown, can include integral focusing elements on its outer faces. In FIG. 1, a negative lens is formed on an incident face 12 and a positive lens is formed on an exiting face 14 of the beam splitter. These integral lenses may be spherical or aspheric, as desired, and they may be replaced with lenses manufactured separately and then attached to flat outer surfaces of the beam splitter. The lenses 12, 14 may be considered to be relay lenses. An exemplary polarizing beam splitter is disclosed in commonly assigned U.S. patent application Ser. No. 11/192,681 entitled-“Method For Making Polarizing Beam Splitters” (Attorney Docket No. 61014US002), filed Jul. 29, 2005 and incorporated herein by reference.

Polarized light from the red, green, or blue channel passes through the hypotenuse of the beam splitter 10 and is incident on the pixilated panel 18, whereupon light reflected from the panel with an orthogonal polarization state reflects off the hypotenuse and exits a side (such as the bottom-most face in FIG. 1) of the polarizing beam splitter 10, to be transmitted through a projection lens and projected onto a screen.

Element 16 is a cover plate for the pixilated panel 18, which is preferably an LCOS panel. The active area of the pixilated panel 18, typically rectangular, coincides with the imager gate (not shown separately). LCOS panels operate in reflection, and on a pixel-by-pixel basis, rotate the plane of polarization of the reflected beam in response to a driving electrical signal. If a particular pixel has a low brightness, then the plane of polarization is rotated only a small amount. If the pixel has a high brightness, then the plane of polarization is rotated by close to ninety degrees. The LCOS may operate on all three wavelengths simultaneously, or may cycle through the colors once for each particular frame (field sequential or color sequential systems). For example, for a refresh rate of 60 Hz, with a full cycle time of ( 1/60) seconds, one possible cycling scheme energizes only the red LED (while turning off the green and blue LEDs) for ( 1/180) seconds, then energizes only the green LED for ( 1/180) seconds, then energizes only the blue LED for ( 1/180) seconds. This is merely an example, and other cycling methods may be employed as desired.

Optionally, the optical system 1 may include one or more anamorphic elements, which can alter the aspect ratio of the beam and, preferably, ensure that the pixilated panel 18 is neither overfilled nor underfilled. Exemplary anamorphic elements include one or more cylindrical lenses, which affect the beam collimation along one particular dimension, but not the orthogonal dimension. Cylindrical lenses may be used in pairs, or may be used singly. A further example is an anamorphic prism, which can compress or expand the beam along one dimension but not along the perpendicular dimension. Anamorphic prisms may be used singly, or may be used in pairs. Any of these optional anamorphic optical elements may be located anywhere in the optical path between the source and the pixilated panel. Furthermore, the optional anamorphic element may be a discrete optical component, such as a cylindrical lens or a prism, or may be incorporated into one or more existing components along the optical path. For instance, anamorphic prisms may be incorporated into the x-cube beamsplitter or the polarizing beam splitter, by placing a wedge on the incident face, the exiting face, or an intermediate face. Alternatively, a cylindrical lens may be incorporated into one of the faces of the beamsplitters, as well.

An exemplary projector system is described in commonly assigned U.S. Patent Application titled “Projection System With Beam Homogenizer” (Attorney Docket No. 61338US002), filed on even date herewith, and incorporated herein by reference.

As shown in FIG. 1, the Fresnel lenses 20 may be considered to be part of a multi-element condenser, which may encompass the entire optical train between the source 2 and the pixilated panel 18. Alternatively, the condenser may be considered to be only one or more optical elements in proximity to the source 2, so that the Fresnel lens pair 20 may be considered to be independent of the condenser. Regardless of whether or not the Fresnel lens pair 20 is part of the condenser, the lens pair 20 has two distinct elements, both of which alter the collimation of a beam passing through them.

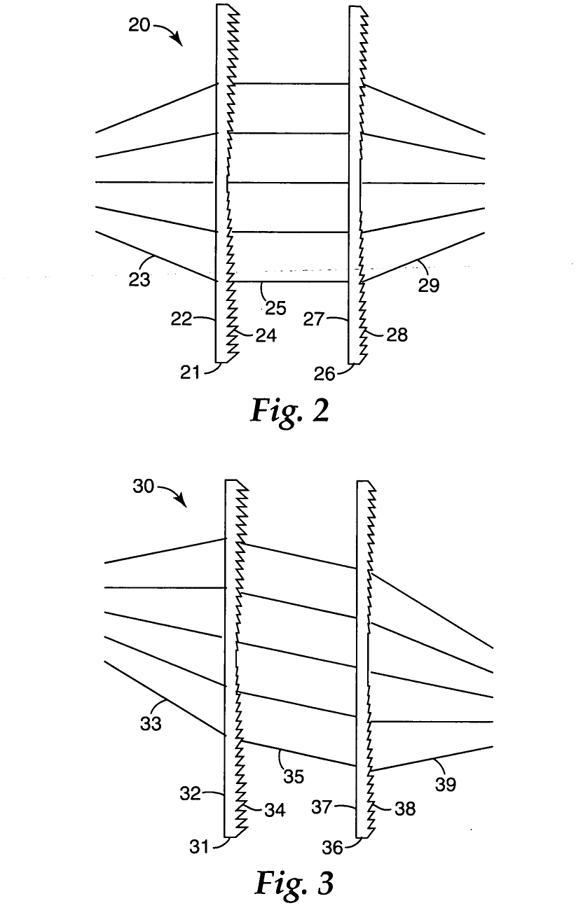

FIG. 2 shows the pair of Fresnel lenses 20 in further detail. A first Fresnel lens 21 collimates an incident non-collimated beam 23, which may emerge directly from a source, or may emerge from one or more intermediate optical elements in the optical path between the source and the first Fresnel lens 21. The incident beam 23 is drawn in FIG. 2 as being diverging, but it may equally well be converging; the degree and sign of collimation of the incident beam 23 depends on the intermediate optical elements between the source and the first Fresnel lens 21.

The first Fresnel lens 21 has a non-faceted side 22 that faces the incident beam 23. The non-faceted side 22 may be planar, or essentially flat to within manufacturing tolerances. Alternatively, the non-faceted side 22 may have a slowly-varying curvature or shape, such as a large spherical radius, an aspherical profile, or a conic profile. Such a curved profile may contain additional optical power, and can potentially reduce the required optical power of the faceted face 24, which in turn may reduce the required number of facets on the faceted face 24, and may help reduce scattering losses from the faceted face 24. The non-faceted side 22 may have an anamorphic profile, such as different radii of curvature along x- and y-directions. The non-faceted side 22 may have an anti-reflection coating on it, which can increase transmission through the first Fresnel lens 21 and reduce unwanted reflections in the optical system 1.

The first Fresnel lens 21 has a faceted side 24 facing away from the incident beam 23. The faceted side 24 contains the features that perform most or all of the focusing in the first Fresnel lens 21. The beam 25 emerging from the faceted side 24 is essentially collimated. The faceted side 24 may optionally be coated with a thin-film antireflection coating, or any other suitable coating.

A Fresnel lens reduces the amount of material required compared to a conventional spherical lens by breaking the lens into a set of concentric annular sections known as Fresnel zones. For each of these zones, the overall thickness of the lens is decreased, effectively chopping the continuous surface of a standard lens into a set of surfaces of the same curvature, with discontinuities between them. This allows a substantial reduction in thickness (and thus weight and volume of material) of the lens, at the expense of reducing the imaging quality of the lens.

The Fresnel zones may have a constant width, with increasing curvatures and increasing facet depths at increasing distances away from the optical axis. Alternatively, the Fresnel zones may have a constant depth, with decreasing widths at increasing distances away from the optical axis. As a third alternative, the Fresnel zones may be arranged in a manner that does not follow either constant width or constant depth.

It should be noted that the local surface slope within each zone of a Fresnel lens faceted surface is essentially the same as the purely refractive surface of its bulk optic counterpart, for a particular distance away from the optical axis. For the configuration of FIG. 2, in which the first Fresnel lens 21 collimates a diverging beam 23, the first Fresnel lens 21 generally functions like a plano-convex lens with its flat side facing the incident diverging beam. The convex side of the bulk optic counterpart plano-convex lens may have a spherical base radius of curvature, with one or more optional aspheric and/or conic terms in its mathematical description. The aspheric and/or conic terms can optionally correct for wavefront aberrations elsewhere in the optical system, by adding or subtracting a prescribed amount of spherical aberration or any other suitable wavefront aberration, such as coma, astigmatism, field curvature, or distortion. The chromatic aberrations of either Fresnel lens in the lens pair 20 are relatively unimportant when the source 2 is relatively monochromatic, such as a single color (e.g. red, green, or blue) LED array.

The refractive indices of both the first Fresnel lens 21 and the second Fresnel lens 26 are typically on the order of 1.5, which is common for optical glasses and plastic materials. Alternatively, the refractive index of one or both lenses may be higher than 1.5, which can reduce the number or the height of the facets on the lens in to achieve a desired power. Reducing the number or height of the facets may in turn lead to a potential reduction in scattering losses from the faceted surfaces.

The collimated beam 25 emerging from the first Fresnel lens 21 strikes the non-faceted surface 27 of the second Fresnel lens 26. In FIG. 2, in which the bundle of rays originates from a point on-axis, the rays all strike the non-faceted surface 27 at normal incidence. For an extended source 2 with a finite spatial extent, the collimated beam will have a range of incident angles on the non-faceted surface 27, the angular range being dependent on the size of the source 2.

The non-faceted face 27 of the second Fresnel lens 26 provides a convenient location for a polarization-sensitive film, such as a reflective polarizer. This location is also convenient when lens 21 produces a collimated beam, such that the range of incidence angles at face 27 is minimum, since the performance of polarization-sensitive components such as reflective polarizers typically changes with increasing incident angle. Exemplary reflective polarizers include coextruded multilayered films discussed in U.S. Pat. No. 5,882,774 (Jonza et al.) and cholesteric reflective polarizers. Exemplary methods of making coextruded multilayered polarizing films are disclosed in U.S. Patent Application Publications US 2002/0180107 A1 (Jackson et al.), US 2002/0190406 A1 (Merrill et al.), US 2004/0099992 A1 (Merrill et al.), and US 2004/0099993 A1 (Jackson et al.). Further exemplary reflective polarizers include Vikuiti™ dual brightness enhancement films (DBEF) available from 3M Company, St. Paul, Minn.

The polarization-sensitive film may be made integral with the second Fresnel lens 26, such as a coating or series of coatings applied directly to the surface. Alternatively, the polarization-sensitive coating may be manufactured separately and then attached to the surface, such as a coating or coatings applied to an intermediate element that is attached or laminated to the non-faceted side 27 of the second Fresnel lens 26, or a polarization-sensitive component that is itself attached to the non-faceted face 27. As a further alternative, the polarization-sensitive element may not be attached to the second Fresnel lens 26 at all, but may be a stand-alone component located in the space between the two lenses.

The faceted side 28 of the second Fresnel lens 26 contains the features that change the collimation of the transmitted beam, similar to the features on the first Fresnel lens 21. In this case, the second Fresnel lens 26 may be a stepwise approximation of a purely refractive plano-convex lens, with the flat side of the bulk optic counterpart plano-convex lens facing the collimated beam. Because the second surfaces of the second Fresnel lens 26 and the bulk optic counterpart plano-convex lens both bring an essentially collimated beam to a focus, the ideal shape may be a hyperbola, which can be represented mathematically by a surface having one or more aspheric and/or conic terms. A hyperbola is especially well-suited for coatings deposited on the faceted surface 28, because the surface slope is essentially constant at large distances away from the optical axis. Alternatively, other suitable surface profiles may be used. As with the first Fresnel lens 21, the faceted surface 28 of the second Fresnel lens 26 may optionally contain corrections for wavefront aberrations elsewhere in the optical system.

The non-collimated beam 29 emerging from the second Fresnel lens 26 is shown as converging, but a diverging beam may also be suitable for some applications, particularly if there are additional optical elements downstream from the Fresnel lens pair 20.

FIG. 3 shows a Fresnel lens pair 30 similar to that of FIG. 2, but with an off-axis bundle of rays. A diverging beam 33 originates from an off-axis point on the source, such as at or near an edge or corner of the source. The diverging beam 33 may also pass through additional optical elements between the source and the Fresnel lens pair 30. The diverging beam 33 strikes a non-faceted surface 32 of a first Fresnel lens 31 and is collimated by a faceted surface 34 of the first Fresnel lens 31. An essentially collimated beam 35 strikes a non-faceted surface 37 of a second Fresnel lens 36 and emerges from a faceted side 38 of the second Fresnel lens 36 as a converging beam 39.

Note that the collimated beam 35 may be slightly converging or slightly diverging if there are significant wavefront aberrations upstream, such as astigmatism or field curvature.

In reality, the beam that propagates from element to element originates from a range of locations, some on-axis and some off-axis, on the extended source. Such a beam propagates with multiple incident angles and locations, in accordance with well-accepted optical principles.

Significantly, the configuration of the Fresnel lens pair 20, in which both non-faceted sides face away from the source, may avoid a problem known as shadowing, as described further below.

In contrast to the configurations of FIGS. 1 and 2, consider a Fresnel lens in which the faceted side faces the incident beam, rather than away from it. A facet 40 from such a lens is shown in FIG. 4. The facet has a refractive index n, typically about 1.5 for common glass or plastic materials, and is surrounded by air with a refractive index of 1. Several exemplary rays are shown propagating from left to right. Ray 42 enters the facet, and is bent downward by refraction at the inclined interface. The ray 42 is then bent downward further by refraction at the rightmost edge of the facet, and exits the lens toward the optical elements downstream. Ray 43, however, enters the facet, but experiences total internal reflection from the edge 45 of the facet, and is redirected out of the optical system. Ray 43 is unfortunately lost to the optical system as scatter. For the geometry of the facet 40 in FIG. 4, there is a particular boundary ray 44 that satisfies the following condition: rays below ray 44 are lost to scatter, and rays above ray 44 are transmitted to the optical elements downstream. The lost rays are shown in the region “x”, compared to the pitch of the facet denoted by “p”, and a linear shadowing effect equal to (x/p) is calculated below from the facet geometry.

For a facet angle α, shown in FIG. 4 as the acute angle 41, and a refractive index of n, the linear shadowing is found to equal sin(a)×sin[α×(n−1)/n]/cos (α/n). Note that to first order, the linear shadowing does not depend on the facet density. In practice, the actual linear shadowing may be slightly less than this value, due to additional scattering through finite rounding of the facet tips during manufacturing of the lens, and surface roughness.

While the facet 40 of FIG. 4 exhibits shadowing, i.e., a loss in light due to total internal reflection from the walls that separate adjacent Fresnel zones, the facet 50 of FIG. 5 exhibits no such shadowing. A ray 52 enters the facet, exhibits little or no deviation by refraction at the entering surface, is refracted by the exiting surface of the facet, and leaves the facet, being directed toward the optical elements downstream. Regardless of the facet angle, denoted by element 51, the lens with its faceted side facing away from the incident beam sees little or no shadowing.

In practice, there may be a small amount of shadowing, due to the finite range of incident angles upon the lens, which range may arise directly from the finite spatial extent of the source. Even in cases of an extended source, with a finite range of incident angles, it is found that compared with Fresnel lenses in which the faceted side faces the incident beam, the Fresnel lenses in which the faceted side faces away from the incident beam (see FIGS. 2 and 3) exhibit far less shadowing.

In general, the configuration in which the faceted side face away from the source exhibit a reduced shadowing for all conjugates. For instance, the incident beam on the lens pair may be diverging, converging, or even collimated. Likewise, the beam between the lenses and/or the beam exiting the lens pair may also be diverging, converging, or even collimated. As an example, when used in an a focal beam expander in which the incident and exiting beams are essentially collimated but may be different sizes, a pair of Fresnel lenses exhibits reduced or eliminated shadowing when the facets on the lens surfaces face away from the source.

Note that orienting the Fresnel lenses so that the faceted sides each face away from the source can reduce shadowing relative to the lens orientation that is commonly used to reduce wavefront aberrations. For instance, for a common condenser that uses two refractive, plano-convex lenses to collect diverging light from a source and bring it to a focus, the plano-convex lenses are typically oriented with their flat sides toward the converging or diverging beams, and their curved sides facing the collimated beam. This orientation of the refractive lenses is known to have reduced spherical aberration and/or coma, compared to other orientations. The Fresnel lens counterpart to this bulk optic plano-convex lens orientation, in which the faceted sides face each other, tends to exhibit more shadowing than the orientation in which the faceted sides both face away from the source.

Note that in FIGS. 1-3, the two Fresnel lenses are separated only by an air gap. As discussed above, certain other optical components can be placed between the Fresnel lenses (e.g. a reflective polarizer or other polarizer, anti-reflective coatings, a retarding film, or a bulk optic beam splitter such as an X-cube color combiner or a polarizing beam splitter), but such components are preferably static (i.e., time-invariant) and/or spatially uniform over the area of the light beam. In either case, whether the Fresnel lenses are separated only by an air gap or by such optical components, they are considered to be “substantially adjacent” for purposes of this application. The Fresnel lenses are not considered to be substantially adjacent if a time-varying and spatially pixilated optical component, such as an LCOS panel or other pixilated display panel, is placed therebetween. In the system of FIG. 1, for example, the pixilated panel 18 is separated from the Fresnel lens pair 20, rather than between the lenses. Similarly, for purposes of this application, a light beam is considered to pass “substantially directly” from one Fresnel lens to another if it passes only through an air gap or static and/or spatially uniform optical components between such Fresnel lenses.

Although the Fresnel lens pair described herein has been shown in the context of a projection system, it may also be used in other suitable optical systems.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A focusing unit, comprising:
a light source for emitting a first non-collimated beam;
a first Fresnel lens having a first non-faceted side for receiving the first non-collimated beam and a first faceted side for emitting a collimated beam; and
a second Fresnel lens having a second non-faceted side for substantially directly receiving the collimated beam and a second faceted side for emitting a second non-collimated beam.

2. The focusing unit of claim 1, wherein the first non-collimated beam is diverging.

3. The focusing unit of claim 1, wherein the second non-collimated beam is converging.

4. The focusing unit of claim 1, wherein the first non-faceted side is planar.

5. The focusing unit of claim 1, wherein the second non-faceted side is planar.

6. The focusing unit of claim 1, wherein the first faceted side is a stepwise aspheric surface.

7. The focusing unit of claim 1, wherein the second faceted side is a stepwise aspheric surface.

8. The focusing unit of claim 7, wherein the second faceted side is a stepwise hyperbolic surface.

9. The focusing unit of claim 1, further comprising a polarization-sensitive optical element disposed proximate the second non-faceted side.

10. The focusing unit of claim 9, wherein the polarization-sensitive optical element is attached to the second non-faceted side.

11. The focusing unit of claim 9, wherein the polarization-sensitive coating is separate from the second non-faceted side.

12. The focusing unit of claim 1, wherein at least one of the first and second non-faceted sides include an anti-reflection coating.

13. The focusing unit of claim 1, wherein the first and second Fresnel lenses are parallel to each other.

14. The focusing unit of claim 1, wherein the first non-collimated beam is emitted from a light diode (LED) or LED array.

15. The focusing unit of claim 14, wherein the first non-collimated beam is emitted from an LED array and wherein all diodes in the array emit light with essentially the same center wavelength.

16. The focusing unit of claim 1, wherein the first non-collimated beam is emitted from at least one laser diode.

17. A projection system comprising the focusing unit of claim 1.

18. The projection system of claim 17, further comprising:
a pixilated panel; and
wherein the second non-collimated beam is directed to the pixilated panel.

19. A focusing unit, comprising:
a light source for emitting a first non-collimated beam;
a first Fresnel lens having a first non-faceted side for receiving the first non-collimated beam and a first faceted side for emitting a collimated beam; and
a second Fresnel lens having a second non-faceted side for receiving the collimated beam and a second faceted side for emitting a second non-collimated beam;
wherein the first and second Fresnel lenses are substantially adjacent.

20. A projection system comprising the focusing unit of claim 19, the system further comprising:
a pixilated panel disposed to be illuminated by the second non-collimated beam.

21. The projection system of claim 20, wherein the collimated beam has a range of incidence angles corresponding to a spatial extent of the light source.

22. The projection system of claim 20, further comprising:
a polarizing beamsplitter disposed between the focusing unit and the pixilated panel.
